(19) United States
(12) Patent Application Publication
(10) Pub. No.: US 2017/0024759 A1
(43) Pub. Date: Jan. 26, 2017

(54) METHODS AND SYSTEMS FOR OPERATING A CUSTOMER LOYALTY PROGRAM

(71) Applicant: MasterCard International Incorporated, Purchase, NY (US)

(72) Inventors: Priyanka Taneja, Gurgaon (IN); Ankur Arora, New Delhi (IN); Suneel Bhatt, Delhi (IN)

(21) Appl. No.: 15/214,774

(22) Filed: Jul. 20, 2016

(30) Foreign Application Priority Data
Jul. 23, 2015 (SG) 10201505754U

(51) Int. Cl. G06Q 30/02; G06Q 20/10; G06Q 20/40

(52) U.S. Cl. CPC G06Q 30/0226; G06Q 20/409; G06Q 20/102

(57) ABSTRACT

A computerized method for operating a loyalty account is proposed in which a customer registers a payment card with a loyalty program of a merchant, and a loyalty account is associated with the payment card. When the customer uses the payment card to make a payment transaction involving the merchant, loyalty points are credited to the loyalty account. Thus, the payment process is a single-step process from the point of view of the customer. The customer presents the payment card to the merchant to make a payment in the conventional manner, and the rest of the process steps to credit loyalty points to the corresponding loyalty account are performed without the involvement of the customer. Conveniently, some of those steps can be performed by computing equipment of the payment network associated with the payment card, which arranges for loyalty points to be credited to a loyalty account associated with the payment card.

### CROSS-REFERENCE TO RELATED APPLICATION

This application is a U.S. National Stage filing under 35 U.S.C. §119, based on and claiming benefit of and priority to SG Patent Application No. 10201505754U filed Jul. 23, 2015.

### FIELD OF THE INVENTION

The present invention relates to a method and system for operating a customer loyalty program in which customers are rewarded for making a purchase from a specific merchant associated with the loyalty program.

### BACKGROUND

It is common for a merchant to organise a loyalty program for its customers. Typically, a customer is provided with a physical loyalty card, which is typically a piece of paper or plastic carrying an account number. The account number is the number of a loyalty account for storing loyalty points earned by the customer. Whenever the customer makes a purchase at a point-of-sale (POS) of the merchant they present the loyalty card. Depending on the value of the purchase, the merchant determines a corresponding number of loyalty points, and credits that number of loyalty points to the account associated with the corresponding card. The accumulated loyalty points can be used to obtain rewards, such as goods and/or services (collectively referred to here as “products”) or a discount on a future purchase from the merchant. The advantage of the rewards system for the merchant is that once the customer has accumulated some loyalty points, he or she is more likely to make future purchases from the same merchant in the hope of eventually earning a reward.

This system has a number of disadvantages. Firstly, it slows down the purchase process, since a customer has to present both a means of payment (e.g. cash or a payment card), and the loyalty card. When the customer is a member of many loyalty programs, locating an appropriate loyalty card in his or her wallet may be time consuming.

Secondly, a customer may forget to bring his or her loyalty card to the merchant when a purchase is to be made, so sometimes purchases are made without benefiting from the loyalty points, leading to customer regret. A customer who is a member of a large number of loyalty programs organised by respective merchants is particularly unlikely to wish to carry all cards for all merchants at all times, increasing the chance that the appropriate loyalty card will not available when the user goes to the merchant. Similarly, a group of customers often share a single loyalty card (e.g. a husband and wife share one card) so one of the customers cannot make use of the loyalty card when another customer of the group is holding it.

To address this second problem it is has been proposed to replace a physical loyalty card with a code number which is a customer's mobile telephone number. In other words, instead of presenting a loyalty card, the customer gives his mobile telephone number. However, this does not address at all the problem that the payment process is delayed: it is still necessary to present two items to the merchant, in this case the payment means and the mobile telephone number.

A third disadvantage of known loyalty card systems is their lack of transparency to the customer, who cannot usually easily ascertain how many loyalty points have already accumulated without contacting or even visiting the merchant. Thus, a customer who has in fact already accumulated significant loyalty points, does not know this, and is not incentivised to use the corresponding merchant again in order to continue to accumulate them. Such a customer may become a member of another loyalty program organised by the merchant's competitor. In other words, the value of the loyalty program is lost both to the merchant and the customer. Furthermore, in many loyalty programs the loyalty points have a finite lifetime, and a customer may not be aware that loyalty points are about to expire. If the customer realizes this too late, when the points have already expired, then the customer has lost his chance to obtain a reward. This may cause him or her such annoyance that he or she stops using the merchant.

### SUMMARY OF THE INVENTION

The present invention aims to provide methods and systems for operating a loyalty program.

In general terms, the invention proposes that a payment card associated with a customer (a “user”) is registered with a loyalty program of a merchant, and a loyalty account is associated with the payment card. When the customer uses the payment card to make a payment transaction involving the merchant, loyalty points are credited to the loyalty account.

Thus, the payment process may be a single-step process from the point of view of the customer. The customer presents the payment card to the merchant to make a payment in the conventional manner, and the rest of the process steps to credit loyalty points to the corresponding loyalty account may be performed without the involvement of the customer. Conveniently, at least some of those steps can be performed by computing equipment of the payment network associated with the payment card, which arranges for loyalty points to be credited to the loyalty account associated with the payment card.

The invention may be expressed as a computer system, such as one operated by a payment network, or as a method performed by the computer system.

Conveniently, the consumer may interrogate the computer system to obtain information about accumulated loyalty points (e.g. how many there are, and/or when they expire) or issue commands (e.g. transferring loyalty points to other loyalty programs). This may be done using a computing device controlled by the consumer. Thus, the invention may also be expressed as a computer device operated by the customer, or as a method performed by that device. It may further be expressed as a computer program product, such as a tangible computer-readable recording medium, storing non-transitory program instructions operative to cause the computer system or computer device to perform the methods.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers.

### BRIEF DESCRIPTION OF THE DRAWINGS

An embodiment of the invention will now be described, for the sake of example only, with reference to the following drawings, in which:

FIG. 1 illustrates schematically a payment system which includes an embodiment of the invention; and

FIG. 2 is a flow-chart of a method performed by the system of FIG. 1.

### DETAILED DESCRIPTION OF THE EMBODIMENTS

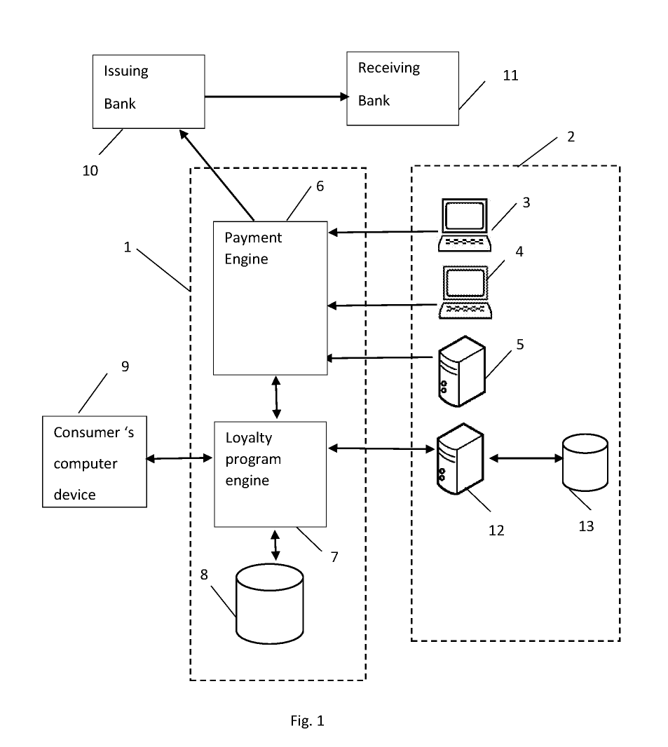

Referring to FIG. 1, an embodiment of the invention is described which is a system for operating a plurality of loyalty programs for respective merchants who each supply goods and/or services (collectively referred to here as “products”).

The system of FIG. 1 includes a payment network 1 for processing payment transactions using a plurality of payment cards, each of which is issued by an issuing bank. Each payment card is associated with a respective customer. Each card is to be used to make a purchase from one of a plurality of merchants who offer products.

The area of FIG. 1 marked 2 indicates schematically elements of a merchant system controlled by one of the merchants. The merchant system 2 includes one or more point-of-sale (POS) terminals 3, 4 located in one or more retail premises. Optionally, the merchant may also operate an e-commerce website controlled by an e-commerce server 5 within the merchant system 2. The merchant furthermore operates a loyalty program, having a number of loyalty accounts associated with respective customers.

Although FIG. 1 only illustrates only one merchant system 2, in reality there are a plurality of merchants, and each merchant may have a respective system of the form of merchant system 2. Each merchant operates a respective loyalty program, which has a number of loyalty accounts associated with respective customers.

The payment network 1 includes a payment engine 6, which may be of conventional design, for processing authorization request messages from the merchants specifying a payment transaction made using one of the payment cards of the payment network. The payment network further includes a loyalty program engine 7 with an associated database 8. The database 8 stores data specifying, for each of the payment cards, one or more of the loyalty programs with which the payment cards is registered. There may be payment cards operated by the payment network 1 which are not registered with any of the merchants' loyalty programs, and the database 8 either does not contain data about these payment cards, or stores data specifying that these cards are not registered with any loyalty program. The payment engine 6 and loyalty program engine 7 may be provided by a single server, or the work of running these two engines may be shared between a plurality of servers.

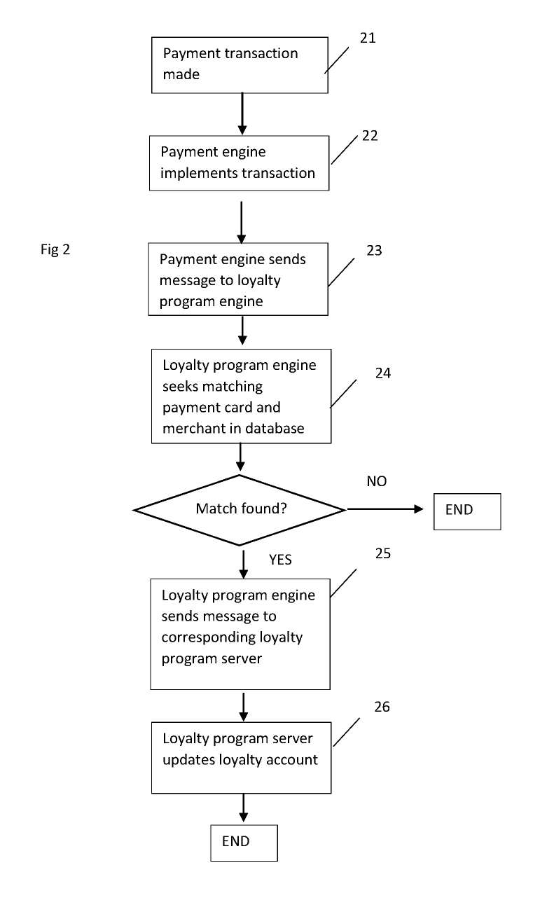

Turning now to FIG. 2, the method performed by the embodiment is shown. It begins with a customer using his or her payment card to make a purchase (step 21) from the merchant who operates the system shown in area 2.

The purchase may be made by presenting the payment card to one of the POS terminals 3, 4. The POS terminal 3, 4 sends an authorization request message detailing the payment transaction to a payment engine 6 of the payment network. The message includes card identity data identifying the payment card, such as a primary account number (PAN) of the payment card, and further includes data specifying the identity of the merchant, and the money amount of the transaction.

Alternatively, the purchase may be made using the e-commerce server 5. In this case, the user may use a computer device 9 operated by the customer to communicate with the e-commerce server 5 (e.g. over the internet) to make an online payment using the payment card. The computer device may be any computer system, such as a personal computer (PC), a laptop computer, or a mobile device, such as a smartphone. The e-commerce server 5 sends an authorization request message detailing the payment transaction to the payment engine 6 of the payment network 1. This message too includes: card identity data identifying the payment card, e.g. the PAN number; data identifying the merchant; and the money amount of the transaction.

In step 22, the payment engine 6 of the payment network 1 processes the authorization request messages it receives by determining whether to authorize the payment transaction (this may include contacting the issuing bank 10 of the payment card to obtain information about whether a payment of the money amount can be authorized), and if so sending a payment authorization message to the issuing bank 10 of the payment card, instructing it to make a payment to the receiving bank 11 (also known as an acquirer or acquiring bank) where the merchant holds an account, and a confirmation message to the merchant terminal/e-commerce server. In FIG. 1 only a single issuing bank 10 is shown (i.e. the one which issued the payment card which was used to make this particular payment transaction). However, typically the payment network 1 will handle payment transactions for a large number of payment cards, each issued by one of a plurality of issuing banks, so, whichever payment card is used the payment network will send the message to the corresponding issuing bank. Similarly, FIG. 1 only shows the receiving bank 11 associated with the merchant system 2, but typically the plurality of merchants will each hold a bank account with one of a plurality of receiving banks.

The payment engine 6 also sends (step 23; note that steps 22 and 23 may be performed in any order) a message to the loyalty program engine 7 of the payment network 1, containing the card identity data of the payment card and also merchant identity data indicating the identity of the merchant.

Upon the loyalty program engine 7 receiving the card identity data, the loyalty program engine uses it to looks up in database 8 whether the payment card is associated with a loyalty program operated by the same merchant identified by the merchant identity data (step 24).

If no match is found the method terminates. Conversely, if such a match is found, then in step 25 the loyalty program engine 10 sends a message to a loyalty program server 12 operated by the same merchant where the payment transaction was made. The message specifies the amount of the purchase, and also contains data identifying a loyalty account associated with the customer. This data may just be the card identity data, or alternatively it may a loyalty account number associated with the payment card and which the loyalty program engine 7 has obtained from the database 8.

In step 26, the loyalty program server 12 uses the message to update a database 13 which records how many loyalty points are in each of the loyalty accounts. The update increases the number of loyalty points by an amount which typically depends upon the size of the purchase. The method then ends.

When the customer wishes to redeem the loyalty points in his or her loyalty account for a specific merchant (e.g. at a time when the user is at one of the POS terminals 3, 4 or is using the computing device 9 to communicate with the e-commerce server 5), the customer can instruct the merchant to interrogate the loyalty program server 12, to obtain from the database 13 the number of available points. The merchant may then reward the customer.

Although in the explanation above, the loyalty program engine 7 and the loyalty program server 12 are shown as separate, in fact a given merchant may opt not to maintain its own loyalty program server 12, but instead to use the loyalty program engine 7 to implement the functionality of the loyalty program server 12 also, i.e. to maintain each of the loyalty accounts, and record (e.g. in the database 8) how many loyalty points are stored in each loyalty account). In this case, when a user wishes to redeem the loyalty points in his or her loyalty account (e.g. at a time when the user is at one of the POS terminals 3, 4 or is using the computing device 9 to communicate with the e-commerce server 5), the customer can instruct the merchant to interrogate the loyalty program engine 7, to obtain from the database 8 the number of available points. The merchant may then reward the customer.

Furthermore, although the example above refers to a single merchant, in fact a group of merchants (i.e. a plurality of merchants) may decide to operate a single common loyalty program. That is, the loyalty program may have a plurality of merchants associated it. The group of merchants may for example agree that when a payment is made to any of the merchants by a payment card registered with the loyalty program, points are credited into an account of the loyalty program associated with the payment card. The group of merchants would typically agree how the points are to be used, e.g. that the points may be spent in future transactions at any of the group of merchants. The group of merchants may together operate a single loyalty program server 12 which maintains the loyalty accounts and records how many points they contain, or the group of merchants may rely on the loyalty program engine 7 to play this role, as described in the preceding paragraph. In both cases, the database 8 of the loyalty program engine 7 would contain data to implement the scheme the group of merchants have agreed: specifically, when it receives information about a payment transaction at any of of the group of merchants, it would identify the loyalty program associated with the group of merchants, and credit the loyalty points to the loyalty account associated with the payment card.

Note that it is already known for use of a payment card to earn loyalty points, which may be stored in a respective loyalty account by a server of the issuing bank 10. That is, in some conventional systems when the equivalent of the payment engine 6 instructs the issuing bank 10 to make a payment to a receiving bank 11, the issuing bank also credits loyalty points to a loyalty account associated with the payment card and maintained in the issuing bank. In embodiments of the present invention, a certain merchant may decide not to run a loyalty program at all, but instead instruct the loyalty program engine 7, when it is informed of a purchase involving the merchant, to credit loyalty points to the loyalty account at the issuing bank. In this case, the merchant does not need the server 12 or the database 13, so, for such a merchant, neither of these may exist. A transfer of funds may be made to the issuing bank from the merchant to compensate for the transfer of loyalty points (i.e. the issuing bank whose loyalty account now contains more loyalty points is financially compensated for the greater obligation to the customer which this implies). Furthermore, if the same payment card has been registered with the loyalty program of a second merchant, it is also possible for the merchant to arrange that the loyalty points are credited to the same customer's loyalty account in the loyalty program of the second merchant. Thus, for example, if a consumer uses a merchant which is bookshop, the bookshop may have instructed the loyalty program engine to deposit the loyalty points into a loyal program of a second merchant which is a coffee shop.

We now turn to the initiation of the system of FIG. 1. Initially, before the loyalty program begins to operate, the merchant (or group of merchants) who operates the system 2 needs to register with the payment network 1. Specifically, the loyalty program is recorded with the loyalty program engine 7. The merchant provides the loyalty program engine 7 with information (“rules data”) describing loyalty program, and this information is stored in the database 8. The rules data specifies which operation(s) the loyalty program engine should perform when the loyalty program engine 7 determines that a payment card has been used which is registered to one of the loyalty programs. If the loyalty program is one in which the loyalty accounts are maintained in a loyalty program server 12 (as shown in FIG. 1), the rules data would specify how to communicate with the loyalty program server 12 (e.g. an Internet address of the loyalty program server 12). Alternatively, if no loyalty program server 12 exists (as described above, this could be because the loyalty program engine 7 performs this role; of because loyalty points are credited to a loyalty account maintained by an issuer bank), the rules data would specify what the loyalty program engine 7 should do when loyalty points are to be awarded (e.g. to credit the loyalty points to an account maintained by the loyalty program engine 7, or to send a message to the issuer bank to instruct the issued bank to credit loyalty points to the loyalty account maintained by the issuer bank).

When a new customer signs up to a loyalty program, the database 8 is updated by entering into it the card identity data of the customer's payment card together with associated data specifying the loyalty program to which the customer signs up (and optionally also an account number of the customer's loyalty account in the loyalty program, if that account number is different from the card identity data). Thus, the payment card is registered to the loyalty program. If this is not the first loyalty program for which the payment card is registered, then the database 8 stores for that payment card a list of all the multiple loyalty programs for which the payment card is registered.

Conveniently, the process of updating the database 8 can be carried out by an application installed on the computer device 9 operated by the customer. The application is downloadable from the payment network 1, e.g. when the user obtains the payment card. The application makes contact with the loyalty program engine 7. The customer then provides input to the computer device 9 to specify the payment card identity data, and to specify the loyalty program. For example, the loyalty program engine 7 may be able to supply to the application data giving details of all the loyalty programs which have been recorded with the loyalty program engine 7, and the user may specify which of the programs he or she wishes to register the payment card with. Alternatively, the customer may be able to control the application to do a search of all the loyalty programs recorded with the loyalty program based on customer-specified criteria (e.g. seeking the loyalty programs of merchants who supply a particular category of product, or who have an outlet in a particular geographical region), and the loyalty program engine 7 may download into the computing device 9 the details of all the loyalty programs matching these criteria.

Subsequently, the customer can use the same application to obtain information about the status of his or her loyalty account with a specific merchant, such as the number of loyalty points accumulated in the loyalty account and/or when these points will expire. The application obtains this information by communicating with the loyalty program engine 7, which in turn requests the information from the loyalty program server 12 of the corresponding merchant. The loyalty program server 12 of the corresponding merchant obtains the data from the corresponding database 13, and passes it to the loyal program engine 7, which in turn transmits it to the application on the computer device 9. Note that the process above may be performed automatically, for example periodically or whenever the application is activated, so that the computer device 9 always has up-to-date information about the loyalty point of all the loyalty accounts associated with the payment card.

A single customer may have multiple payment cards, each registered with a different set of one or more of the loyalty programs. In this case, the application may obtain information for each payment card, specifically about each of the loyalty program(s) for which the payment card is registered.

Further, is common for a group of customers (e.g. two or more members of the same household or the same commercial organisation) to have associated respective payment cards. In this case, registration of one of the payment cards with a loyalty program may have the effect that all the associated payment cards are registered with the loyalty program, either being associated with respective loyalty accounts (so that the customers individually accumulate loyalty points in their own respective loyalty accounts) or a single loyalty account (so that the group of customers collectively accumulate loyalty cards in the same loyalty account).

Using the application on the computing device 9, the user may also be able to perform other control operations on the loyalty program engine 7. For example, the loyalty program engine 7 may be controllable by the application to transfer points to/from a loyalty account of the issuing bank from/to a customer's loyalty account with one of the merchants. A money payment may be made to/from the issuing bank from/to the merchant to compensate for the transfer of loyalty points (i.e. the one of the merchant and issuing bank whose loyalty account now contains more loyalty points is financially compensated for the greater obligation to the customer which this implies).

In another example, in the case of a customer whose payment card is registered with the respective loyalty programs of two or more merchants, the application may be operative to control the loyalty program engine 7 to transfer loyalty points from the customer's loyalty account at one of those merchants to a loyalty account at another of those merchants. Again a money payment may be made between the merchants to compensate for the transfer of loyalty points. In this way, a customer who tends to earn points when purchasing products with one merchant can use them in a loyalty program of another merchant whose rewards the customer regards more highly for some reason. This makes the loyalty points earned at a certain merchant intrinsically more valuable, since there are more options for redeeming them. Indeed, a certain merchant may cease to offer rewards at all, knowing its customers will still be able to benefit from by using the loyalty points in the reward programs of other merchants. There may be restrictions on which loyalty accounts customers are empowered to transfer loyalty points between, for example preventing them from transferring loyalty points between merchants which are competitors.

The payment network 1 may be able to automatically suggest pairs of merchants for which transfers of loyalty points may be valuable. For example, the payment network may be operative to notice that statistically customers who tend to patronise a certain merchant in a first industry, tend to patronise a certain second merchant in a second industry. In this case, the possibility of transferring loyalty points earned from a purchase at one of those merchants to a loyalty program operated by the other of the two merchants may be attractive. So, the payment network may be operative to suggest to the two merchants that such a tie-up should be made possible. If the merchants agree, they may together instruct the loyalty program engine 7 accordingly, to make the loyalty program engine 7 operative to transfer points between the loyalty programs of the respective merchants in at least one direction.

Although in the explanation above, some of the control of the loyalty program engine 7 is by an application running on the user's computer device 9, the server implementing the loyalty program engine 7 may alternatively provide a web interface to which the computing device 9 can connect to issue these commands. That is, a browser on the computer device 9 can be used to interact with the web interface, to have some or all of the functionality of the application described above.

Although only a single embodiment of the invention has been explained in detail, many variations are possible within the scope and spirit of the invention, as will be clear to a skilled reader. For example, the loyalty program server 12 for a given merchant may be omitted, and instead its role can be played by functionality of the loyalty program engine 7. That is, the loyalty program engine 7 may maintain the loyalty accounts for the each of one more of the merchant's respective loyalty programs. In this case, the loyalty program engine 7 would store (e.g. in the database 8) for each loyalty account, the number of loyalty points accumulated (and optionally data specifying when they will expire). When the user wishes to redeem the points (e.g. at a time when the user is at one of the POS terminals 3, 4 or using the computing device 9 to communicate with the e-commerce server 5), the user can provide the payment card and instruct the merchant to interrogate the loyalty program engine 7 to determine how many loyalty program points are available.

1. A computer system for processing payment transactions, the computer system comprising:
a payment engine component operative (a) to receive an authorization request message specifying a payment transaction to a merchant, the payment transaction involving a payment card and for a specific amount, (b) transmit a payment authorization message to a card issuer associated with the payment card terminal; and
a loyalty program engine component operative to determine whether the payment card is registered with a loyalty program associated with the merchant, and in the case that the determination is positive, operative to credit loyalty points to a loyalty account associated with the payment card.

2. A computer system according to claim 1 further comprising a database storing:
for each of one or more loyalty programs, a respective set of one of more payment cards registered with the loyalty program, and
rule data describing the one or more loyalty programs;
wherein the loyalty program engine component is operate to determine whether the payment card is registered with a loyalty program by accessing the database,
and in the case that the determination is positive, to credit the loyalty points to the loyalty account according to the rule data describing the corresponding loyalty program.

3. A computer system according to claim 2 in which the rule data includes data for at least one of the loyalty programs instructing the loyalty program engine component to credit the loyalty points to the loyalty account by transmitting a message to a loyalty program server associated with the merchant.

4. A computer system according to claim 2 in which the rule data includes data for at least one of the loyalty programs instructing the loyalty program engine component to credit the loyalty points to a loyalty account maintained by the loyalty program engine component.

5. A computerized method performed by a computer system for processing a payment transaction, the method comprising:
(i) receiving an authorization request message specifying a payment transaction and including payment card identity data identifying a payment card used to make a purchase from the merchant,
(ii) transmitting a payment authorization message to a card issuer associated with the payment card; and
(iii) determining whether the payment card is registered with a loyalty program associated with the merchant; and
in the case that the determination is positive, (iv) crediting loyalty points to a loyalty account associated with the payment card.

6. A computerized method according to claim 5 in which step (iii) of determining whether the payment card is registered with a loyalty program is performed by accessing a database of the computer system, the database storing for each of a plurality of payment cards a respective set of one or more loyalty programs.

7. A computerized method according to claim 5 in which the loyalty account is operated by the merchant, and the loyalty points are redeemable for rewards from the merchant.

8. A computerized method according to claim 5 in which the loyalty program is associated with a plurality of merchants, and the loyalty points are redeemable for rewards from any of the merchants.

9. A computerized method according to any of claim 5, further including receiving command input from a user associated with the payment card, and in response to the input transmitting to the user information about the loyalty points in the loyalty account.

10. A computerized method according to any of claim 5, further including receiving a command input from a user associated with the payment card, and in response to the input transferring loyalty points from the loyalty account to a second loyalty account, the second loyalty account being associated with a second loyalty program which is not associated with the merchant.

11. A computerized method according to any of claim 5 in which step (iv) of crediting loyalty points to the loyalty account associated with the payment card is performed by transmitting an instruction to a server operated by the merchant.

12. A computing device associated with a user, the device comprising:
a data input device for receiving first input from the user specifying a payment card associated with the user; and second input specifying a loyalty program; and
a data interface for communicating with a payment network associated with the payment card;
a processor; and
a data storage device storing program instructions operative when implemented by the processor to cause the processor to generate a message for transmission to the payment network by the data interface, encoding the first and second input.

13. A computerized method performed by a computing device associated with a user, the method comprising:
the computing device receiving first input from the user specifying a payment card associated with the user;
the computing device receiving second input specifying a loyalty program; and
the computing device transmitting to a payment network associated with the payment card a message indicating that the payment card is to be registered with the loyalty program,
whereby the payment network can associate the payment card with a loyalty account of the loyalty program, and upon the payment network identifying that a payment transaction with the merchant using the payment card has been authorized, the payment network can credit loyalty points to the loyalty account.

14. A computerized method according to claim 13 further including:
the computing device receiving input from the user requesting information about loyalty points in the loyalty account;
the computing device communicating with the payment network to obtain the information, and
the computing device presenting the information to the user.

15. A computerized method according to claim 13 further comprising:
the computing device receiving input from the user instructing the transfer of loyalty points from/to the loyalty account to/from a second loyalty account;
the computing device transmitting a command to the payment network to instruct the payment network to effect the transfer.

16. A non-transitory computer-readable medium having stored thereon program instructions for causing at least one processor to perform a computerized method comprising:
receiving first input from the user specifying a payment card associated with the user;
receiving second input specifying a loyalty program; and
transmitting to a payment network associated with the payment card a message indicating that the payment card is to be registered with the loyalty program,
whereby the payment network can associate the payment card with a loyalty account of the loyalty program, and upon the payment network identifying that a payment transaction with the merchant using the payment card has been authorized, the payment network can credit loyalty points to the loyalty account.
